(19) United States
(12) Patent Application Publication
(10) Pub. No.: US 2011/0001262 A1
(43) Pub. Date: Jan. 6, 2011

(54) Method for manufacturing an electronic component

(76) Inventors: Wolf-Ingo Ratzel, Stuttgart (DE); Matthias Ludwig, Moessingen (DE)

Correspondence Address: KENYON & KENYON LLP, ONE BROADWAY, NEW YORK, NY, 10004, US

(21) Appl. No.: 12/802,807

(22) Filed: Jun. 14, 2010

(30) Foreign Application Priority Data
Jul. 1, 2009 (DE) 10 2009 027 391.3

(51) Int. Cl. B29C 45/14; B29C 39/02; B29C 45/03

(52) U.S. Cl. 264/255; 264/250

(57) ABSTRACT

A method for manufacturing an electronic component includes: inserting a microcomponent into a receptacle device, the receptacle device fixing the microcomponent in relation to a shaping tool; extrusion-coating the microcomponent using a first coating; extrusion-coating the first coating using a second coating, the first coating and the second coating forming a housing; and pulling the receptacle device out of the housing before the solidification of the second coating and/or before the complete filling of the shaping tool using the second coating.

### BACKGROUND OF THE INVENTION

1. Field of the Invention

The present invention relates to a method for manufacturing an electronic component, e.g., an acceleration sensor, and also relates to an electronic component for use in vehicle technology.

2. Description of Related Art

It is known from the related art to extrusion-coat microelectromechanical components, such as airbag acceleration sensors, using plastic and to thus manufacture a housing for the sensor. However, the method according to the related art has the disadvantage that the location of the sensors in relation to the external contour of the housing is not able to be ensured during the manufacturing method. Even a slight inclination or tilting of the sensor in relation to its external contour and in relation to its interface in the vehicle results in significant measuring errors, however.

### BRIEF SUMMARY OF THE INVENTION

The methods according to the present invention for manufacturing an electronic component make it possible to extrusion-coat a microcomponent, e.g., an acceleration sensor, in an exact location with respect to its coatings or casings. It is thus ensured that the microcomponent is in an exactly defined location in relation to the external contour of its housing. Measuring errors as a result of inclined sensors are thus avoided.

These advantages are achieved by the method according to the present invention for manufacturing an electronic component, which includes the following steps: inserting a microcomponent into a receptacle device, the receptacle device fixing the microcomponent in relation to a shaping tool, extrusion-coating the microcomponent using a first coating, extrusion-coating the first coating using a second coating, the first coating and the second coating forming a housing, pulling the receptacle device out of the housing before the solidification of the second coating and/or before the complete filling of the shaping tool with the second coating.

Alternatively, a method for manufacturing an electronic component is proposed, which includes the following steps: inserting a microcomponent into a receptacle device, the receptacle device fixing the microcomponent in relation to a shaping tool, extrusion-coating the microcomponent using a first coating, pulling the receptacle device out of the first coating before the extrusion-coating using a second coating, extrusion-coating of the first coating using the second coating, the first coating and the second coating forming a housing.

Two variants according to the present invention for manufacturing the electronic components are thus proposed, the variants sharing the feature that the microcomponent is fixed by the receptacle device in relation to the shaping tool at least during the extrusion-coating using the first coating. The microcomponent thus no longer floats through injection of the first coating during the casting procedure or injection molding procedure, but rather is coated uniformly and in a defined position by the first coating. The microcomponent used according to the present invention may in turn be made of individual subelements, such as microelectromechanical sensors, microchips, or further electronic components. Furthermore, the microcomponent is already enclosed using a first housing, only terminals or contacts advantageously still protruding from this first housing. The term shaping tool is understood both as an injection mold, in particular for use with an injection molding machine, and also as a casting mold. It is decisive that in the case of the particular tool, the cavity is provided for the corresponding coating. The receptacle device is pulled out before the solidification of the second coating and/or before the complete filling of the shaping tool with the second coating in the case of the first variant according to the present invention. The receptacle device is advantageously continuously extracted with the filling procedure of the second coating, so that the space which the receptacle device occupies may be continually filled up with the material of the second coating.

In an advantageous embodiment of the second alternative of the method according to the present invention, it is provided that during the extrusion-coating using the second coating, a further receptacle device fixes the first coating having an embedded microcomponent in relation to the shaping tool, the further receptacle device being pulled out of the housing before the solidification of the second coating and/or before the complete filling of the shaping tool using the second coating. Thus, in order to exactly position the finished first coating in relation to the second coating, the first coating is held on its external contour using a further receptacle device. This further receptacle device is advantageously placed at the same position as the receptacle device for holding the microcomponent. This further receptacle device is in turn pulled out of the housing before the solidification of the second coating and/or before the complete filling of the shaping tool using the second coating. The further receptacle device is advantageously extracted from the coating continuously with the filling procedure of the second coating, so that the space which the further receptacle device occupies is continuously filled up using the second coating.

Furthermore, the function of the further receptacle device may advantageously also be fulfilled by the first-described receptacle device. In this case, the receptacle device is pulled out of the first coating before the extrusion-coating using the second coating, the receptacle device advantageously fixing the first coating having the embedded microcomponent in relation to the shaping tool during the extrusion-coating using the second coating, the receptacle device being pulled out of the housing before the solidification of the second coating and/or before the complete filling of the shaping tool with the second coating. The same receptacle device is thus first placed on the microcomponent and then on the first coating here.

The advantageous embodiments described hereafter are used for all above-described variants of the method according to the present invention.

It is advantageously provided that openings in the housing which remain due to the extraction of the receptacle device and/or the further receptacle device are at least partially closed using post-pressure. The term “post-pressure” means that material for the first coating and/or second coating is kept under pressure, in order to at least partially or completely fill cavities arising as a result of the extraction of the receptacle device and/or the further receptacle device. In particular the remaining openings in the second coating are to be closed using post-pressure on the second coating if an injection molding machine is used, for example. In particular in the case of the advantageous continuous pulling of the receptacle devices simultaneously with the filling of the second coating, only small openings remain, which may be readily closed after the complete removal of the receptacle device using post-pressure.

Furthermore, it is advantageously provided that the receptacle device and/or the further receptacle device each represent a three-point receptacle. The receptacle device for fixing the microcomponent thus has three receptacle points, at most two of the receptacle points lying on one line. In a similar way, the further receptacle device for fixing the first coating is advantageously designed with three receptacle points, at most two of the receptacle points lying on one line, in order to fix the first coating. These three-point receptacles ensure that the microcomponent or the first coating is fixed using neither overdetermination nor underdetermination of the degrees of freedom.

In a further advantageous embodiment, it is provided that the first coating and the second coating are manufactured in a two-component injection mold. The receptacle device and/or the further receptacle device may advantageously be provided as movable components within the two-component injection mold.

The advantageous material selection provides that the first coating is made of a soft plastic, in particular an elastomer, in particular silicone, and the second coating is made of a hard plastic, in particular a thermoplastic. The second coating, which also forms terminal points or interfaces of the sensor, for example, is made of hard plastic, in particular thermoplastic. Relatively high pressures are required for the injection molding of such a thermoplastic. Therefore, the microcomponent is advantageously protected by the soft first coating. Furthermore, if a soft first coating is used, the receptacle device may be pulled relatively easily out of the first coating.

In a further advantageous embodiment, the electronic component includes at least one terminal pin, which is fastened, in particular soldered or welded, to the microcomponent. This terminal pin is advantageously at least partially exposed from the first coating and the second coating. The terminal pin may thus advantageously be used for a plug contact, for example, to a cable. The electronic component advantageously includes two such terminal pins.

In an advantageous embodiment of the second coating, it includes a molded fastening element and/or a molded terminal element. This molded fastening element is advantageously designed for fastening the electronic component. The molded fastening element includes a bush for this purpose, for example, via which the electronic component may be screwed into a vehicle. The molded terminal element is advantageously designed for a plug connection for this purpose. The free ends of two terminal pins are advantageously located in this plug connection, so that the electronic component may be connected to a cable.

Furthermore, the present invention includes an electronic component for use in vehicle technology, in particular as an airbag sensor, manufactured according to one of the above-described methods, the microcomponent including a microelectromechanical sensor. It is advantageous in particular in vehicle technology to enclose sensors using a strong and robust casing. However, the location of the sensor relative to its casing or relative to the screw points on its casing must be defined simultaneously, so that measuring errors may be largely prevented. The advantageous embodiments, described in the scope of the two methods according to the present invention, are, of course, also applied correspondingly to the electronic component according to the present invention and its use in vehicle technology.

### BRIEF DESCRIPTION OF THE DRAWINGS

FIG. 1 shows a schematic view of the finished electronic component according to one exemplary embodiment.

FIG. 2 shows a microcomponent, as it is used in the electronic component according to the exemplary embodiment.

FIG. 3 shows the microcomponent as it is fixed by a receptacle device according to the exemplary embodiment.

FIG. 4 shows the receptacle device according to the exemplary embodiment in detail.

FIG. 5 shows the microcomponent having a first coating according to the exemplary embodiment.

FIG. 6 shows the electronic component according to the exemplary embodiment shortly before completing the second coating.

### DETAILED DESCRIPTION OF THE INVENTION

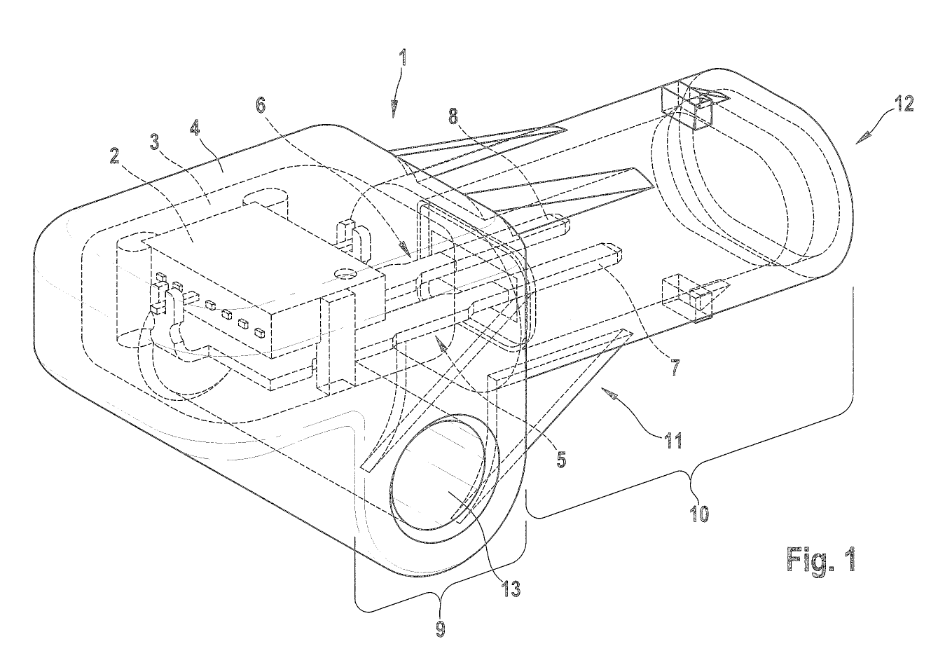

An exemplary embodiment of the present invention is explained in greater detail hereafter on the basis of FIGS. 1 through 6.

FIG. 1 shows a complete electronic component 1, in the form of an airbag acceleration sensor for a motor vehicle, manufactured as per the method according to the present invention. Electronic component 1 includes a microcomponent 2, in the form of a microelectromechanical sensor, within a housing 11, made of a first coating 3 over a second coating 4.

First coating 3, which is made of silicone, completely encloses microcomponent 2. First coating 3 is in turn completely enclosed by second coating 4, made of a thermoplastic. A molded fastening element 9 and a molded terminal element 10 are formed on second coating 4. Molded fastening element 9 includes a bush 13, by which electronic component 1 may be screwed onto an interface in a vehicle. Molded terminal element 10 includes a cavity, which represents a plug terminal 12. This plug terminal 12 is used for the purpose of connecting a plug or a cable for the electrical contact to microcomponent 2 securely to electronic component 1.

A first terminal pin 5 and a second terminal pin 6 are attached to microcomponent 2 (the precise connection between the terminal pins and the microcomponent is shown in FIG. 3). First terminal pin 5 and second terminal pin 6 are used for the purpose of establishing an electrical or electronic contact to the microcomponent via plug terminal 12. First terminal pin 5 and second terminal pin 6 are partially concealed by first coating 3 and second coating 4. However, in order to ensure an electrical contact, a first contact surface 7 of first terminal pin 5 and a second contact surface 8 of second terminal pin 6 remain exposed within plug terminal 12 and extend into the cavity of plug terminal 12.

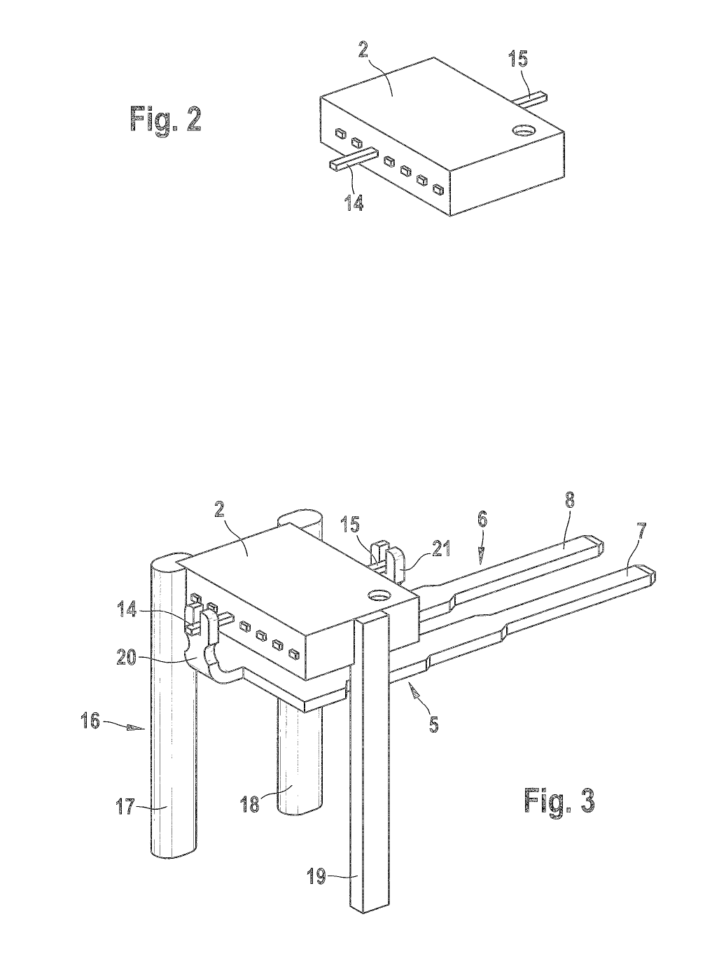

FIG. 2 shows a microcomponent 2 as it is extrusion-coated in electronic component 1 according to the exemplary embodiment. Microcomponent 2 essentially includes a square plastic housing, a first microcomponent terminal 14 and a second microcomponent terminal 15 protruding on diametrically opposite sides. Diverse components, such as a microelectromechanical sensor for acceleration measurement and microchips and connection wires, are located within the plastic housing. First microcomponent terminal 14 and second microcomponent terminal 15 are connected via a weld bond, for example, to first terminal pin 5 and second terminal pin 6. This is shown in detail in FIG. 3.

FIG. 3 shows how microcomponent 2 according to the exemplary embodiment is fixed in a receptacle device 16. Furthermore, FIG. 3 shows how first terminal pin 5 and second terminal pin 6 are connected to first microcomponent terminal 14 and second microcomponent terminal 15.

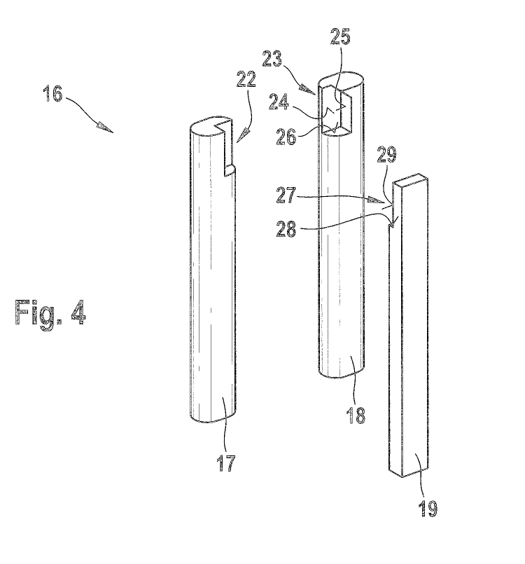

Receptacle device 16 is located inside a two-component injection mold, via which electronic component 1 according to the exemplary embodiment is manufactured. For this purpose, receptacle device 16 is situated in a movable manner in the two-component injection mold and may be extended into the corresponding injection molding cavity and extracted therefrom again. In a simplified view, receptacle device 16 is shown here having a first receptacle support 17, a second receptacle support 18, and a third receptacle support 19, without the injection molding cavity. First receptacle support 17 and second receptacle support 18 each fix microcomponent 2 on an adjacent corner. Third receptacle support 19 fixes microcomponent 2 along a side diametrically opposite to the two corners. A three-point support is thus ensured without overdetermination or underdetermination of the degrees of freedom. The precise design of receptacle device 16 required for this purpose is shown in FIG. 4.

Furthermore, FIG. 3 shows that first terminal pin 5 and second terminal pin 6 are each essentially formed by an oblong sheet-metal strip. One end of first terminal pin 5 is bent over by 90° to form a first connection extension 20. This first connection extension 20 is welded to first microcomponent terminal 14. The end of second terminal pin 6 is also bent upward by 90° and thus forms a second connection extension 21, which is welded to second microcomponent terminal 15. The particular other ends of first terminal pin 5 and second terminal pin 6, which are not connected to microcomponent 2, each form above-described first contact surface 7 and second contact surface 8 of plug 12.

FIG. 4 shows receptacle device 16 according to the exemplary embodiment without microcomponent 2 in detail. It may be seen how a first corner receptacle 22 is formed on first receptacle support 17 and a second corner receptacle 23 is formed on second receptacle support 18. A longitudinal side receptacle 27 is correspondingly formed on the third receptacle support. Microcomponent 2 rests in its fixed location on these corner receptacles 22, 23 and on this longitudinal side receptacle 27.

The construction of first corner receptacle 22 and second corner receptacle 23 is described hereafter for exemplary purposes on the basis of first corner receptacle 22. First corner receptacle 22 includes a first surface 24, a second surface 25, and a third surface 26. These three surfaces 24, 25, 26 are each perpendicular to one another and all three surfaces 24, 25, 26 intersect at one point. Diametrically opposite to first corner receptacle 22 and second corner receptacle 23, longitudinal side receptacle 27 has a fourth surface 28, which is parallel to third surface 26, and a fifth. surface 29, which is parallel to first surface 24 and perpendicular to second surface 25. Microcomponent 2 is fixed exactly in its six degrees of freedom by this special design of receptacle device 16. Overdetermination of the fixation was avoided in order to optimally compensate for tolerances both on microcomponent 2 and also on receptacle device 16.

If the second variant according to the present invention is used, according to which a further receptacle device supports first coating 3 during the injection of second coating 4, this further receptacle device is accordingly implemented as a three-point receptacle precisely like receptacle device 16 of the exemplary embodiment.

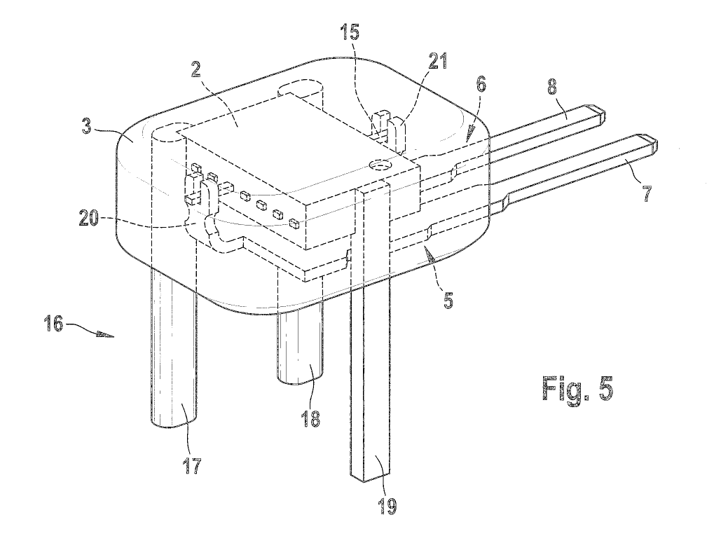

FIG. 5 shows how the microcomponent was extrusion-coated, together with a part of first terminal pin 5 and second terminal pin 6 and with a part of receptacle device 16, using the silicone of first coating 3. For better illustration, the two-component injection mold was blanked out again here. Of course, the injection molding cavity of this mold corresponds in this method step to that in the first form of first coating 3 shown.

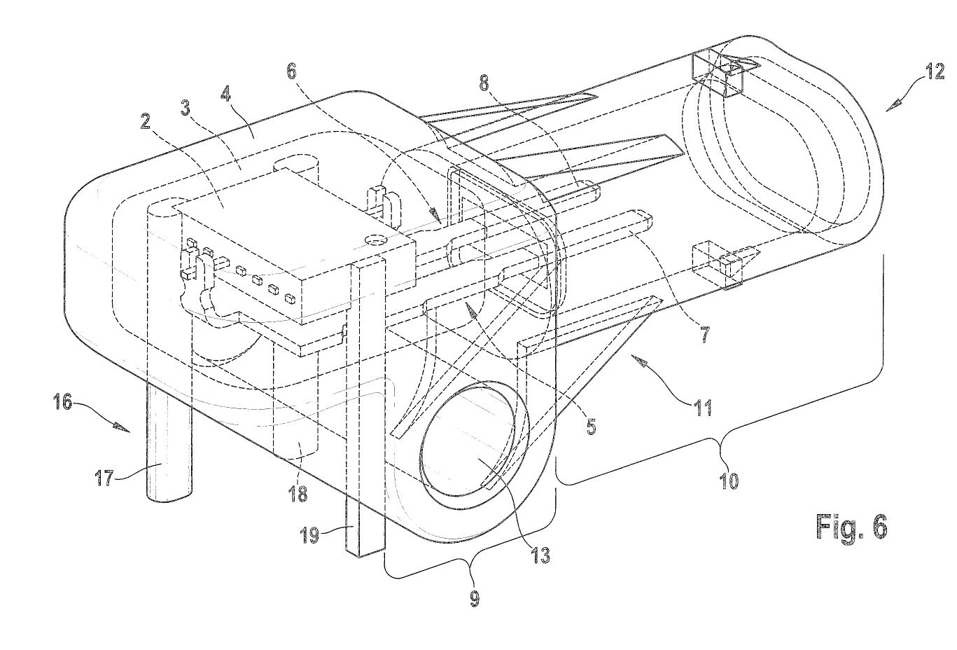

FIG. 6 shows electronic component 1 shortly before being finished and thus shortly before receptacle device 16 is extracted from housing 11. The two-component injection mold is again blanked out here. However, it is obvious that the injection molding cavity of the mold approximately corresponds to the inverse shape of second coating 4 shown in this method step. Before the plastic of second coating 4 has been completely injected or has completely solidified in this method step, receptacle device 16 is extracted from housing 11 and the remaining post-pressure at the injection molding machine then optimally completely fills the remaining cavities, which arise due to extraction of receptacle device 16. It is decisive above all that the external cavities in second coating 4 are closed.

It was shown on the basis of this exemplary embodiment how microcomponent 2 may already be exactly fixed during the extrusion-coating of first coating 3, so that microcomponent 2 no longer “floats” in first coating 3. In order to exactly position microcomponent 2 and first coating 3 during the extrusion-coating, receptacle device 16 remains in the injection molding cavity or in housing 11 until shortly before the completion of second coating 4. This manufacturing method ensures that microcomponent 2 is in an exact location in relation to bush 13 of molded fastening element 9. Measuring errors as a result of a tilted or inclined installation location of a microelectromechanical sensor for acceleration measurement are thus largely avoided.

What is claimed is:

1. A method for manufacturing an electronic component, comprising:
inserting a microcomponent into a receptacle device, wherein the receptacle device fixes the microcomponent in relation to a shaping tool;
extrusion-coating the microcomponent using a first coating;
extrusion-coating the first coating using a second coating, wherein the first coating and the second coating form a housing; and
pulling the receptacle device out of the housing at least one of (a) before the solidification of the second coating and (b) before complete filling of the shaping tool using the second coating.

2. A method for manufacturing an electronic component, comprising:
inserting a microcomponent into a receptacle device, wherein the receptacle device fixes the microcomponent in relation to a shaping tool;
extrusion-coating the microcomponent using a first coating;
pulling the receptacle device out of the first coating before extrusion-coating using a second coating;
extrusion-coating the first coating using the second coating, wherein the first coating and the second coating form a housing.

3. The method as recited in claim 2, wherein during the extrusion-coating using the second coating, a further receptacle device fixes the first coating having the embedded microcomponent in relation to the shaping tool, and wherein the further receptacle device is pulled out of the housing at least one of (a) before the solidification of the second coating and (b) before complete filling of the shaping tool using the second coating.

4. The method as recited in claim 1, wherein an opening remaining in the housing due to the extraction of the receptacle device is at least partially closed using post-pressure.

5. The method as recited in claim 1, wherein the receptacle device represents a three-point receptacle.

6. The method as recited in claim 1, wherein the first coating and the second coating are manufactured in a two-component injection mold.

7. The method as recited in claim 1, wherein the first coating is a soft plastic in the form of an elastomer and the second coating is a hard plastic in the form of a thermoplastic.

8. The method as recited in claim 7, wherein the first coating and the second coating leave at least one terminal pin of the electronic component at least partially exposed.

9. The method as recited in claim 8, wherein the second coating includes at least one of (i) a molded fastening element configured to fasten the electronic component and (ii) a molded terminal element configured for a plug connection.

10. The method as recited in claim 8, wherein the microcomponent includes a microelectromechanical sensor.
